(19) United States
(12) Patent Application Publication
(10) Pub. No.: US 2026/0103923 A1
(43) Pub. Date: Apr. 16, 2026

(54) Vehicle Door for a Motor Vehicle, and Motor Vehicle

(71) Applicant: BAYERISCHE MOTOREN WERKE AKTIENGESELLSCHAFT, München (DE)

(72) Inventors: Erik BRADEN, Muenchen (DE); Markus KOEDDERITZSCH, Woerthsee (DE)

(21) Appl. No.: 19/114,824

(22) PCT Filed: Oct. 13, 2023
(86) PCT No.: PCT/EP2023/078462

§ 371 Date: Mar. 25, 2025

(30) Foreign Application Priority Data
Oct. 19, 2022 (DE) 10 2022 127 590.6

(51) Int. Cl. E05B 85/18; B60J 5/00

(52) U.S. Cl. CPC E05B 85/18; B60J 5/00

(57) ABSTRACT

A vehicle door having a handle situated on the outside of the door, wherein an operator control element is integrated into the handle, a lock, by way of which the vehicle door can be secured in its closed position, being electrically unlockable by the operator control element. The handle is movably from an inoperative position (R) to at least one operating position (B), the lock being mechanically unlockable by moving the handle element from the inoperative position (R) to the operating position (B). Additionally, an operating device is configured to move the handle element from the inoperative position (R) to an intermediate position situated between the inoperative position (R) and the operating position (B) and can be held in the intermediate position.

### BACKGROUND AND SUMMARY

This disclosure relates to a vehicle door for a motor vehicle, in particular for a passenger car. The disclosure also relates to a motor vehicle, in particular a passenger car, having at least one such vehicle door.

WO 2007/118552 A1 discloses a motor vehicle having a vehicle door which has a door lower part and an upper window part, which are separated by a window shoulder. WO 2020/01137 A1 discloses an apparatus for actuating a vehicle door of a vehicle, having a sensor device which is designed to detect a force acting on the vehicle door and to generate corresponding sensor data. Furthermore DE 10 2017 202 114 A1 discloses a motor vehicle having at least one side door, which has a door body. Furthermore, WO 2006/007916 A1 discloses a motor vehicle door having an inner module and an outer module. Moreover, DE 10 2010 101 164 A1 discloses a door handle unit for actuating a lock of a door or a flap.

The object of the present disclosure is to create a vehicle door for a motor vehicle, in particular a passenger car, and to create a motor vehicle, in particular a passenger car, such that particularly advantageous operation can be realized.

A first aspect of the disclosure relates to a vehicle door, which is also referred to simply as a door and is in the form, for example, of a side door, for a motor vehicle, which is preferably in the form of a passenger car and is also referred to as a vehicle. This means that the motor vehicle, which is also referred to as a vehicle, and the interior of which, which is also referred to as the passenger cabin or passenger compartment, is formed by a structure of the motor vehicle that is in the form, in particular, of a self-supporting body, has the structure and the vehicle door in its completed state. The vehicle door has a handle element on the outside of the door, which handle element, in particular in the installed position of the vehicle door, which adopts its installed position in the completed state of the motor vehicle, is arranged above a door shoulder of the vehicle door in the vehicle vertical direction. The handle element is also referred to as the outer handle or door outer handle. In the completed state of the motor vehicle, the vehicle door is held on the structure so as to be movable, in particular pivotable, such that the vehicle door is arranged or able to be arranged, that is to say is held or can be held, on the structure so as to be movable, in particular pivotable. In particular, the vehicle door is assigned a structure opening in the structure, the structure opening of which is in particular a door opening. If the vehicle door is a side door, the door opening is a side door opening, which, as seen for example in the vehicle transverse direction of the motor vehicle, is arranged on a left-hand or right-hand side of the structure or of the motor vehicle. The vehicle door can be moved, in particular pivoted, relative to the structure between a closed position and at least one open position. In the closed position, at least a subregion of the structure opening is closed by the vehicle door. In the open position, the vehicle door opens up the subregion of the structure opening, such that, for example in the open position of the vehicle door, a person can get into or out of the interior via the opened-up subregion of the structure opening. In particular, provision is made for the handle element, in the installed position of the vehicle door and with respect to the closed position of the vehicle door, to be arranged above the door shoulder in the vehicle vertical direction of the motor vehicle. The door shoulder is also referred to simply as the shoulder or window shoulder or edge or beltline, or the door shoulder is formed by a beltline or coincides with the beltline. In particular, the door shoulder is or forms an edge, in particular a lower edge, by way of which for example a window opening for a window, in particular for a side window, of the vehicle door is at least partially delimited, in particular in the installed position of the vehicle door and downwardly in the vehicle vertical direction of the motor vehicle with respect to the closed position of the vehicle door.

By way of example, a person located in the surroundings of the motor vehicle and thus in the surroundings of the vehicle door can take hold of the handle element with their hand and in the process, for example, at least partially grasp it, and, for example, subsequently exert a force on the handle element and thus, via the handle element, on the vehicle door, in order in this way to handle the vehicle door, i.e., in particular, to be able to move it, in particular pivot it, relative to the structure. By way of example, the person can exert such a force on the vehicle door via the handle element that the vehicle door is opened by the force, and is thus moved relative to the structure from the closed position into the open position. Furthermore, for example, the person located in the surroundings can exert such a force on the handle element and thus on the vehicle door that the vehicle door is closed by the force, and is thus moved from the open position into the closed position. The feature whereby the handle element is arranged on the outside of the door or externally, and is thus an external handle element or a handle element on the outside of the door, should be understood as meaning that the handle element is arranged on an outer side of the vehicle door, the outer side of which, in the installed position of the vehicle door and at least in the closed position of the vehicle door, faces away from the interior and faces the surroundings.

In order now for it to be possible to realize a particularly advantageous operation, i.e. actuation, of the vehicle door, in particular via the handle element, the disclosure provides that an operating element is integrated into the handle element. This means in particular that the operating element is held on the handle element or is a constituent part of the handle element. In particular, it is conceivable for the operating element to be held on a base of the handle element, wherein it is conceivable for the operating element to be formed separately from the base. The operating element may be held on the base, or on the handle element, so as to be immovable, but also so as to be movable, in particular pivotable. By way of the operating element, a lock, also referred to as a door lock, by way of which the vehicle door, which is arranged or able to be arranged on the structure of the motor vehicle so as to be movable, in particular pivotable, between the closed position and the at least one open position, can be secured in the closed position in particular relative to the structure, can be unlocked electrically. In order thus to open, for example, the vehicle door which is initially in the closed position and is thus locked and secured in the closed position in particular relative to the structure by way of the lock, the person, for example, located in the surroundings operates, in particular actuates, the operating element, with the result that the lock is unlocked electrically, i.e. with the result that electric unlocking of the lock is brought about. In particular, the person touches the operating element in the process.

By way of the lock, the vehicle door, which is arranged or arrangeable on the structure of the vehicle (motor vehicle) so as to be movable, in particular pivotable, between the closed position and the at least one open position, is or can be secured in the closed position, in particular relative to the structure, such that an undesired movement of the vehicle door from the closed position into the open position is avoided. As a result of the lock being unlocked, the lock enables the vehicle door to be moved from the closed position into the open position. In particular, the lock may be a constituent part of the vehicle door such that the lock is movable, in particular pivotable, conjointly for example with the vehicle door relative to the structure between the closed position and the open position. The lock may, for example, be adjusted between a locked state and an unlocked state. As a result of the lock being unlocked, the lock is moved, i.e. transferred, from the locked state into the unlocked state. If the vehicle door is, for example, in the locked position, and if, at the same time, the lock is in the locked state, the vehicle door is secured by way of the lock in the closed position and thus secured against undesired movement relative to the structure. It is apparent that the vehicle door is a leaf element which is arranged or able to be arranged on the structure so as to be movable, in particular pivotable, between the open position and the closed position. In this case, the vehicle door (leaf element) is, in particular, an attachment part that is formed separately from the structure and is or can be held on the structure so as to be movable between the open position and the closed position. In order, for example, to open the vehicle door that is initially closed and is thus initially in the closed position, and thus to move it from the closed position into the open position, the operating element is operated, in particular actuated, in particular by the person located in the surroundings. As a result of the operation, in particular actuation, of the operating element, the lock is unlocked electrically, and is thus transferred electrically from the locked state into the unlocked state, such that the lock enables the vehicle door to move relative to the structure from the closed position into the open position. For example, a locking element, for example a lock striker, also referred to as a lock bolt or locking bolt or as a striker, is fastened to the structure, in particular to a vehicle pillar, in the form for example of a door pillar and also referred to as a body or structure pillar, of the structure. In the closed position of the vehicle door and in the locked state of the lock, the lock, for example, in particular a fork latch of the lock, cooperates, in particular in a positive locking manner, with the locking element, with the result that the vehicle door is or can be secured in a positive locking manner in the closed position.

By way of example, the lock has a lock element which may be, for example, the abovementioned fork latch. In the closed position of the vehicle door and in the locked state of the lock, the lock element, for example, cooperates with the locking element, in particular in a positive locking manner, with the result that the vehicle door is or can be secured, in particular in a positive locking manner, in the closed position. By way of example, the lock element may be moved, in particular in translation and/or rotation, between a locked position and an unlocked position relative to a basic element of the lock and in particular relative to the locking element. In the closed position of the vehicle door and in the locked position of the lock element, the lock element cooperates, in particular in a positive locking manner, with the locking element, with the result that the vehicle door is or can be secured in the closed position. As a result of the lock being unlocked, or while it is being unlocked, the lock element, for example, is moved from the locked position into the unlocked position, in which there is no cooperation of the lock element with the locking element. As a result, the vehicle door is allowed to move relative to the structure from the closed position into the open position.

The operating element may be, for example, a mechanical operating element, for example a button or a pushbutton, such that the operating element can be moved, in particular in translation and/or rotation, for example, between a starting position and an operating position relative to the handle element and/or relative to the abovementioned base. As a result of the operating element being operated, in particular actuated, the operating element is, for example, moved relative to the handle element and/or relative to the base from the starting position into the operating position, with the result that the lock can be unlocked electrically, and thus with the result that electric unlocking of the lock can be brought about. It is also conceivable for the operating element to be in the form of a touch-sensitive surface or to comprise a touch-sensitive surface, wherein the operating element is operated, i.e. can be operated, by touching the touch-sensitive surface.

The feature whereby, as a result of the operating element being operated, in particular actuated, the lock is unlockable electrically, should be understood in particular as meaning that, for example, as a result of the operating element being operated, an electrically operable actuator, in particular an electric motor, is actuated, in particular electrically. As a result of the actuator being actuated, the actuator is electrically operated, such that, by way of the actuator, for example the lock element is moved from the locked position into the unlocked position, in particular using electrical energy and thus electrically. This means that the lock element is moved electrically from the locked position into the unlocked position, with the result that the lock is unlocked electrically, i.e. using the abovementioned electrical energy. A movement, following the electric unlocking of the lock, of the vehicle door from the closed position into the open position can, for example, then be brought about manually by the person located in the surroundings, in particular by the person manually exerting a force, in particular a pulling force or a pushing force, on the handle element and thus moving the vehicle door relative to the structure from the closed position into the open position. Furthermore, it is conceivable that, as a result of the operating element being operated, the vehicle door is moved or movable relative to the structure electrically, i.e. using electrical energy, from the closed position into the open position, in particular after the lock has been unlocked, in particular electrically. To this end, provision is made, for example, of an electrically operable moving device which has, for example, the abovementioned electrically operable actuator and/or at least one further electrically operable actuator. As a result of the operating element being operated, the moving device, for example, is actuated, in particular electrically, with the result that the moving device moves, in particular pivots, the vehicle door using electrical energy and thus electrically relative to the structure from the closed position into the open position. Thus, the lock can be unlocked particularly comfortably, and the vehicle door can be opened, and thus be moved from the closed position into the open position, particularly comfortably.

Furthermore, to realize particularly advantageous operation, in particular actuation, of the vehicle door, provision is made for the handle element to be held on a base body, also referred to as a door body, of the vehicle door so as to be movable, in particular pivotable, relative to the base body from a rest position into an actuating position, in particular between the rest position and the actuating position, wherein, as a result of the handle element being moved from the rest position into the actuating position, the lock is unlockable mechanically, preferably without the use of electrical energy. In other words, as a result of the handle element being moved relative to the base body from the rest position into the actuating position, the lock can be unlocked mechanically, in particular purely mechanically and thus without the use of electrical energy. Preferably, the rest position and the actuating position are respective end positions of the handle element, which moves relative to the base body into the respective end position, but cannot be moved beyond the respective end position. Very particularly, the vehicle door is designed such that, as a result of the operating element being operated, in particular actuated, the lock is unlockable electrically, i.e. without the handle element moving from the rest position into the actuating position, i.e. while there is no movement of the handle element from the rest position into the actuating position. As a result, particularly advantageous, in particular particularly comfortable and at the same time reliable, operation of the vehicle door can be realized. In this case, the handle element has at least a dual function: firstly, since the operating element is integrated into the handle element, the handle element can be used to be able to electrically and thus particularly comfortably unlock the lock and, for example, as a result, to be able to handle the vehicle door easily, ergonomically and thus advantageously via the handle element. Secondly, the handle element may act as, be in the form of or be used as an emergency unlocking operating element, wherein the emergency unlocking operating element is also referred to as an emergency unlocking mechanism or an emergency unlocking element. This means, in particular, the following: For example, the operating element is or comprises a sensor, also referred to as a detection sensor, which is operable, for example, electrically or electronically or may be an electric or electronic sensor. The detection sensor may, in particular, be arranged in the handle element or in the base. By way of the detection sensor, it is possible to detect, for example, operation of the operating element that is effected by the person located in the surroundings. Thus, it is conceivable for the sensor to be a constituent part of the operating element. If, for example, operation of the operating element that is effected by the person, i.e., in particular, a movement of the operating element that is effected by the person, from the starting position into the operating positions, is detected by way of the detection sensor, then, in particular as described above, the first actuator is actuated such that the lock is unlocked electrically by way of the first actuator. The first actuator may, for example, be a constituent part of the vehicle door. Furthermore, it is conceivable for the detection sensor to be a constituent part of the vehicle door (leaf element), in particular such that the detection sensor is integrated into the handle element. In particular, the detection sensor may be the operating element or a constituent part of the operating element. In principle, it is possible, for example as a result of the motor vehicle being involve in an accident, for the operating element and/or the sensor and/or the first actuator no longer to be able to be supplied with electrical energy or electric current, since, for example, a power supply of the operating element and/or of the first actuator and/or of the sensor (detection sensor) has been damaged, interrupted or destroyed. Then, the lock may possibly no longer be unlocked electrically since, for example, the first actuator can no longer be operated and/or since, for example, operation or actuation of the operating element can no longer be detected by way of the detection sensor and/or since operation of the operating element can no longer be detected by the operating element itself. Since, however, the disclosure now provides that the handle element itself and thus, in particular, together with the operating element, can be moved relative to the base body from the rest position into the actuating position, with the result that the lock can be unlocked mechanically, in particular purely mechanically, the handle element is (also) or (also) acts as an emergency unlocking operating element. As a result, it is possible, in particular when the power supply has failed, for the lock to be unlocked mechanically, i.e., in particular, to be unlocked in an emergency. For this purpose, the person located in the surroundings, for example, moves the handle element and, by way of the handle element, moves the operating element from the rest position into the actuating position. As a result, a particularly high level of reliability can be realized, such that particularly advantageous and reliable operation can be provided. Moreover, the use of an additional, separate emergency unlocking operating element can be avoided, and so particularly advantageous and reliable operation of the vehicle door can be realized in a space-optimized and weight-optimized manner, and cost-effectively. Furthermore, a particularly advantageous visual impression of the vehicle door and of the motor vehicle as a whole can be realized, since, for example, impairment of the visual impression of the motor vehicle by an additional, separate emergency unlocking operating element can be avoided.

Furthermore, the disclosure provides that the vehicle door has an actuating device, by way of which the handle element is movable, in particular movable actively, in particular depending on at least one predefinable or predefined criterion and/or depending on at least one event, relative to the base body from the rest position into an intermediate position located between the rest position and the actuating position and can be held, i.e. is able to be fixed, in the intermediate position relative to the base body. The feature whereby the intermediate position is located between the rest position and the actuating position should be understood as meaning that the handle element is movable from the rest position via the intermediate position into the actuating position relative to the base body, and thus that the handle element, on its way from the rest position into the actuating position, passes at least temporarily into the intermediate position, and thus at least temporarily takes up the intermediate position. In this case, the intermediate position is a stable position of the handle element, which is fixed or able to be fixed in the intermediate position relative to the base body, such that, in the intermediate position, there are no relative movements between the handle element and the base body. This means, in particular, that following a movement of the handle element, effected, in particular automatically, by the actuating device, from the rest position into the intermediate position, the handle element remains in the intermediate position such that there are no relative movements between the handle element and the base body. By way of example, the handle element is movable from the intermediate position into the actuating position manually and thus, for example, by the person located in the surroundings, in particular in order, as a result, to unlock the lock mechanically, in particular purely mechanically.

Since, according to the disclosure, the actuating device is now provided, by way of which the handle element is movable from the rest position into the intermediate position and, in the process, in particular in the direction of the actuating position, and is able to be fixed, in particular, in the intermediate position relative to the base body, the person located in the surroundings is, as it were, presented with the handle element. Therefore, the intermediate position is also referred to as the presentation position. In other words, as a result, the person located in the surroundings is made in particular visually aware that the lock can be unlocked mechanically by moving the handle element from the intermediate position into the actuating position. If the person, for example, visually perceives that the handle element is in the rest position, the person is made visually aware that the person can operate the operating element and can subsequently unlock the lock electrically. If the person, however, visually perceives that the handle element is in the intermediate position, the person can be made visually aware that the person has to or can move the handle element from the intermediate position into the actuating position relative to the base body in order, as a result, to unlock the lock mechanically and subsequently to open the vehicle door. This is particularly advantageous during or after an accident. In this case, for example, the person is a rescue worker who is made visually aware by the intermediate position that the handle element needs to or can be moved relative to the base body. If this is carried out by the person such that the person moves the handle element from the intermediate position into the actuating position relative to the base body, the lock is unlocked mechanically, and as a result, the vehicle door can be opened. As a result, particularly reliable and thus advantageous operation or actuation of the vehicle door can be ensured.

In order for it to be possible to realize particularly advantageous operation of the vehicle door, one embodiment of the disclosure provides that the handle element has an outer skin that is visually and haptically perceivable by a person located in the surroundings of the vehicle door, in particular of the motor vehicle as a whole. The outer skin of the handle element is also referred to as the handle element outer skin. In other words, the person located in the surroundings can see the outer skin with their eyes and thus visually perceive it, and the person located in the surroundings can, for example, directly touch the outer skin with their hand, in particular with their fingers, and thus haptically perceive it, in particular in the completed state of the vehicle door and in particular of the motor vehicle as a whole. The outer skin is thus a surface of the handle element that is visually and haptically perceivable by the person located in the surroundings or is formed by such a surface. In this case, it is, in particular, conceivable for the abovementioned, touch-sensitive surface to be a part, referred to as detection part, of the handle element outer skin. In particular, it is conceivable for the vehicle door as a whole to have an outer skin, also referred to as overall outer skin, that is visually and haptically perceivable by the person located in the surroundings, wherein the previous and following statements about the handle element outer skin can readily also be transferred to the overall outer skin and vice versa. In this case, in particular, the handle element outer skin is a first part of the overall outer skin. For example, the vehicle door has a shell, also referred to as door shell, wherein it is conceivable, in particular in the completed state of the motor vehicle, for the vehicle door to be held or able to be held on the structure of the motor vehicle so as to be movable, in particular pivotable, via the shell. In other words, for example, the vehicle door is or can be held on the structure so as to be movable, in particular pivotable, via the shell. To this end, provision is made, for example, for the vehicle door to have at least a first hinge part, which is fastened, in particular secured, for example, at least indirectly, in particular directly, to the shell. The first hinge part is, for example, a constituent part of a hinge, also referred to as a door hinge, which also has a second hinge part formed, in particular, separately from the first hinge part. The second hinge part is fastened or able to be fastened at least indirectly, in particular directly, to the shell of the motor vehicle, in particular at the abovementioned vehicle pillar. The hinge parts are connected or able to be connected together in a movable, in particular pivotable, manner such that the shell, via the hinge, and, via the shell, the vehicle door as a whole is arranged or able to be arranged, i.e. is or can be held, on the structure so as to be movable, in particular pivotable. For example, the shell is formed at least partially from a metal material. In this case, it is conceivable in particular for the shell to be a constituent part of the base body. Furthermore, it is conceivable for the vehicle door, in particular the base body, to have an outer paneling element, also referred to simply as a paneling element. By way of example, the outer paneling element is formed separately from the shell and fastened, in particular directly, to the shell. The outer paneling element is also referred to as a door panel or door outer panel. At least one region of the shell is covered and thus clad by the outer paneling element toward the surroundings, and thus toward the outside, i.e. in a direction away from the interior of the motor vehicle, in particular with regard to the closed position of the vehicle door and in the installed position of the vehicle door. In this case, the outer paneling element has, for example, an outer skin, also referred to as paneling outer skin, wherein the previous and following statements about the handle element outer skin and about the overall outer skin can readily also be transferred to the paneling outer skin and vice versa. In this case, the paneling outer skin is or forms, for example, a second part of the overall outer skin of the vehicle door. In particular, it is conceivable for at least a part of the outer paneling element and thus of the paneling outer skin, in the installed position of the vehicle door and in this case in particular in the closed position of the vehicle door, to adjoin the window opening and/or the door shoulder downwardly in the vehicle vertical direction of the motor vehicle.

In order for it to be possible to realize particularly advantageous operation, in particular actuation, of the vehicle door, provision is advantageously made for the handle element to have a first subregion, forming a first part of the handle element outer skin, also referred to as first body part, the first subregion having a first extension direction and thus extending along the first extension direction. In this case, it is conceivable for the first subregion to protrude from the base body in or along the first extension direction. The first extension direction is also referred to as first direction. In the installed position of the vehicle door and in the closed position of the vehicle door, the first direction extends, for example, in the vehicle transverse direction, in particular outwardly and thus toward the surroundings. Thus, provision is preferably made for the first subregion to protrude from the base body in the first direction.

Furthermore, the handle element preferably has a second subregion, also referred to as second body part, which forms a second part of the handle element outer skin. The second subregion of the handle element adjoins the first subregion of the handle element, in particular at an end of the first subregion of the handle element that faces away from the base body, wherein the second subregion of the handle element protrudes from the first subregion of the handle element in a second extension direction, also referred to as second direction, which extends obliquely or perpendicularly to the first extension direction (first direction). As a result, the second subregion is, for example, spaced apart from the base body and arranged so as to at least partially overlap the base body. In particular, the second subregion extends along the second extension direction. In the installed position of the vehicle door and with regard to the closed position of the vehicle door, the second direction (second extension direction) extends, for example, upwardly in the vehicle vertical direction or the second direction is directed upwardly in the vehicle vertical direction. For example, in the installed position of the vehicle door and with regard to the closed position of the vehicle door, the second subregion of the handle element is overlapped inwardly in the vehicle transverse direction and thus toward the interior by the base body and thus, for example, by a part of the paneling outer skin. As a result, it is possible, for example, for the person located in the surroundings to take hold of, in particular to grip behind, the handle element, in particular the second subregion of the handle element, particularly advantageously and ergonomically with their hand, in particular such that, for example, the person can move at least one of their fingers or several of their fingers between the second subregion of the handle element and the base body. Then, the person can exert a force particularly advantageously on the handle element in order, as a result, to particularly advantageously handle the vehicle door, i.e. to be able, in particular, to move it, in particular pivot it, relative to the structure.

In order to be able to realize haptically particularly advantageous and in particular ergonomic and comfortable operation, in particular actuation, of the vehicle door, a further refinement of the disclosure provides that, since the second subregion protrudes from the first subregion in the second extension direction, the handle element, in particular overall and thus considered as a whole, is L-shaped or V-shaped and thus has an L-shape or V-shape. In this case, the subregions of the handle element form the L-shape or the V-shape, wherein the subregions of the handle element are respective legs of the L-shape or of the V-shape. In this case, provision is made in particular for the handle element to be attached to the base body via the first subregion of the handle element.

A second aspect of the disclosure relates to a vehicle door, which is also referred to as a door and is in the form, for example, of a side door, for a motor vehicle, which is preferably in the form of a passenger car and is also referred to as a vehicle. For the first aspect of the disclosure and the second aspect of the disclosure, the respective vehicle door may preferably be in the form of a side door or of a rear door. Of course, the respective vehicle door can also be in the form of some other door. The previous statements about the first aspect of the disclosure can be readily also transferred to the second aspect of the disclosure and vice versa.

The vehicle door according to the second aspect of the disclosure has a handle element arranged on the outside of the door, beneath a door shoulder of the vehicle door according to the second aspect of the disclosure, the handle element thus be an outer handle that is also referred to as a door outer handle. Advantages and advantageous refinements of the first aspect of the disclosure are considered to be advantages and advantageous refinements of the second aspect of the disclosure and vice versa. Thus, for example, the vehicle door according to the second aspect of the disclosure is arranged or able to be arranged on a structure of the motor vehicle so as to be movable, in particular pivotable, in particular such that the vehicle door according to the second aspect of the disclosure can be moved, in particular pivoted, relative to the structure between a closed position and at least one open position. In this case, the handle element of the vehicle door according to the second aspect of the disclosure, in the installed position of the vehicle door according to the second aspect of the disclosure and in particular in the closed position of the vehicle door according to the second aspect of the disclosure, is arranged beneath the door shoulder of the vehicle door according to the second aspect of the disclosure in the vehicle vertical direction of the motor vehicle, wherein the vehicle door according to the second aspect of the disclosure takes up its installed position in the completed state of the motor vehicle.

In the second aspect of the disclosure, an operating element is integrated into the handle element, by way of which operating element a lock, by way of which the vehicle door, which is able to be arranged on the structure of the motor vehicle so as to be movable, in particular pivotable, between the closed position and the at least one open position, is able to be secured in the closed position, in particular relative to the structure, is unlockable electrically. In this case, the handle element is held on a base body of the vehicle door so as to be movable relative to the base body from a rest position into an actuating position, in particular between the rest position and the actuating position, wherein, as a result of the handle element being moved from the rest position into the actuating position, the lock is unlockable mechanically, in particular purely mechanically. In the second aspect of the disclosure, the handle element has an outer skin, also referred to as a handle element outer skin, that is visually and haptically perceivable by a person located in the surroundings of the vehicle door, wherein the handle element also has a first subregion, forming a first part of the handle element outer skin of the handle element and also referred to as a first body region or first body part, which has a first extension direction. The first extension direction is also referred to as the first direction. The first subregion extends along the first extension direction. By way of example, the first subregion of the handle element protrudes from the base body of the vehicle door in the first direction (first extension direction). Furthermore, the handle element, in the second aspect of the disclosure, has a second subregion, forming a second part of the handle element outer skin of the handle element and adjoining the first subregion, the second subregion also being referred to as a second body region or second body part and protruding from the first subregion in a second extension direction extending obliquely or perpendicularly to the first direction. In particular, the second subregion extends along the second extension direction, which is also referred to as the second direction. Since the second subregion protrudes from the first subregion in the second direction, the second subregion is, for example, spaced apart from the base body and arranged so as to at least partially overlap the base body.

Since the second subregion protrudes from the first subregion in the second extension direction (second direction), the handle element, in particular overall and thus considered as a whole, is L-shaped or V-shaped, such that the handle element, in particular considered as a whole, has an L-shape or a V-shape. In this case, the L-shape or the V-shape is formed by the subregions, which form or are respective legs of the L-shape or V-shape. Advantages and advantageous refinements of the first aspect of the disclosure should be considered to be advantage and advantageous refinements of the second aspect of the disclosure.

In the second aspect of the disclosure, too, the handle element may fulfill at least a dual function. Firstly, the handle element is used in order for it to be possible, in particular since the operating element is integrated into the handle element, to electrically unlock the lock particularly easily and thus comfortably and ergonomically. Furthermore, the vehicle door can be handled easily, ergonomically and thus comfortably via the handle element. Secondly, the handle element, in the second aspect of the disclosure too, can act or be in the form of a mechanical emergency unlocking operating element, since, as a result of the handle element being moved relative to the base body from the rest position into the actuating position, the lock can be unlocked mechanically, in particular purely mechanically.

The feature whereby, in the second aspect, the handle element is arranged beneath the door shoulder in the vehicle vertical direction, should be understood as meaning that the handle element is arranged beneath the door shoulder in the vehicle vertical direction at least in the rest position. Preferably, the handle element is also arranged above the door shoulder in the vehicle vertical direction in the actuating position.

As a result of the L-shape or the V-shape, the vehicle door can be actuated particularly comfortably and ergonomically via the handle element, such that particularly advantageous operation is able to be provided.

In the second aspect of the disclosure, an actuating device is provided, by way of which the handle element, is movable, in particular movable actively, in particular depending on at least one predefinable or predefined criterion and/or depending on at least one event, relative to the base body from the rest position into an intermediate position located between the rest position and the actuating position and can be held, i.e. is able to be fixed, in the intermediate position relative to the base body. As a result, the person located in the surroundings can be visually made aware that the handle element can and needs to be moved into the actuating position in order to unlock the lock mechanically.

Advantageously, provision may be made, in the vehicle door according to the disclosure, for the actuating device to have an actuator, which is operatively connected to an energy supply, located in the motor vehicle, for providing electrical energy, in particular a drive battery of the motor vehicle. As a result, the actuator is formed in an electrically operable manner and designed to move the handle element from the rest position into the intermediate position.

In order for it to be possible to move the handle element particularly appropriately and particularly quickly from the rest position into the intermediate position, provision is made, in one embodiment of the disclosure, for the actuating device to have an actuator and an energy store which is assigned specifically to the actuator, that is to say especially and for example only to the actuator, and is formed preferably separately from the actuator, and in which energy is stored. The actuator is able to be supplied with the energy stored in the energy store independently of the rest of the motor vehicle, with the result that the actuator is operable. As a result of the actuator being operated, the handle element can be moved, in particular actively, from the rest position into the intermediate position.

In this case, it has been found to be particularly advantageous for the energy stored in the energy store to be electrical energy, such that the energy store is designed to store electrical energy, and is thus in the form of an electrical energy store. Thus, the actuator is an electrically operable actuator which is able to be supplied with the electrical energy stored in the electrical energy store and is electrically operable as a result. As a result, the handle element can be moved appropriately and particularly quickly from the rest position into the intermediate position. By way of example, the electrical energy store is or comprises at least one supercapacitor, which is also referred to as a supercap or an ultracapacitor. Furthermore, it is conceivable for the electrical energy store to be or comprise a battery, in particular a secondary battery. In particular, it is conceivable for the electrical energy store to be able to be supplied with electrical energy, via an electrical system of the motor vehicle, from a further, additional electrical energy store of the motor vehicle, such that the electrical energy from the further electrical energy store can be stored in the electrical energy store of the actuating device and used to operate the actuator. Since the energy store is assigned specifically to the actuator, the actuator can be operated and thus the handle element can be moved from the rest position into the intermediate position by way of the actuator in particular even when the abovementioned power supply has been interrupted or destroyed.

A further embodiment is characterized in that the actuating device has at least one, in particular mechanical, spring element which is tensioned at least in the rest position and as a result provides a spring force by way of which the handle element is movable, in particular automatically, from the operating position into the intermediate position in particular as a result of an accident and/or as a result of failure of a power supply of the motor vehicle. For example, the spring element is tensioned, in particular compressed, at least in the rest position, wherein, for example, a retention element, for example a hook, is provided, by way of which the spring element, also referred to simply as a spring, is kept tensioned. For example, the retention element is held on a basic element so as to be movable, in particular pivotable. For example, as a result of an accident and/or in the event of failure of the power supply, the retention element is moved or movable relative to the basic element, with the result that the retention element releases the spring element, in particular automatically, for at least partial relaxation of the spring element. The subsequently relaxed spring element can move the handle element out of the rest position into the intermediate position relative to the base body, in particular by way of the spring force, with the result that particularly advantageous, in particular particularly reliable operation of the vehicle door can be provided particularly easily.

In order for it to be possible to ensure particularly reliable and thus particularly advantageous operation, in particular actuation, of the vehicle door, a further refinement of the disclosure provides that the actuating device is designed to move the handle element automatically from the rest position into the intermediate position if the motor vehicle is involved in an accident. For example, this accident is detected, in particular electrically or electronically, by way of a detection device. The detection device may provide a signal characterizing the detected accident, wherein, depending on the signal, for example the abovementioned actuator of the actuating device is actuated. As a result, the actuator is operated, which, as a result, moves the handle element from the rest position into the intermediate position. Furthermore, it is conceivable, in the event of an accident, for accident-related acceleration to act on the retention element such that the retention element is moved relative to the basic element in such a way that the retention element releases the tensioned spring element. Subsequently, the spring element can at least partially relax and, by way of its spring force, move the handle element from the rest position into the intermediate position relative to the base body.

Finally, to realize particularly reliable and thus advantageous operation of the vehicle door, it has been found to be particularly advantageous for the actuating device to be designed to move the handle element automatically from the rest position into the intermediate position in the event of an interruption to a power supply of the operating element and/or actuating device and/or at least one other, further component of the motor vehicle. To this end, provision is made, for example, for the actuating device to be designed to provide a retaining force in an energized state, by way of which the spring element is kept tensioned. The interruption to the power supply results in removal of the retaining force, with the result that the spring element is released for at least partial relaxation of the spring element. Subsequently, the spring element can at least partially relax and thus move the handle element from the rest position into the intermediate position. Alternatively or additionally, it is possible, for example, for the actuating device to identify the interruption to the power supply, in particular by receiving a signal, in particular an electric signal, characterizing the interruption to the power supply. Subsequently, it is possible, for example, for the actuator of the actuating device to be actuated, with the result that, subsequently, the actuator can move the handle element from the rest position into the actuating position.

Alternatively or additionally, provision may be made for the actuator or a further, in particular electrically operable actuator of the actuating device, in an energized state of the actuator, to keep the abovementioned retention element in a retention position in which the retention element keeps the spring element tensioned. As a result of the interruption to the power supply, the actuator or the further actuator passes into a deenergized state of the actuator or of the further actuator, with the result that the holding of the retention element, effected initially by the actuator or the further actuator, ends, with the result that the retention element is moved relative to the basic element, or the actuator or the further actuator releases the retention element for such a movement in particular relative to the basic element, such that the retention element releases the spring element for at least partially relaxation of the spring element. Subsequently, the at least partially relaxing spring element can move the handle element from the rest position into the actuating position relative to the door body.

### BRIEF DESCRIPTION OF THE DRAWINGS

Further details of the disclosure will become apparent from the following description of preferred exemplary embodiments together with the accompanying drawings.

FIG. 1 shows a detail of a schematic perspective view of a vehicle in the form of a motor vehicle, in particular of a passenger car, having a vehicle door according to a first embodiment;

FIG. 2 shows a detail of a schematic sectional view of the first embodiment of the vehicle door;

FIG. 3 shows a detail of a schematic plan view of the vehicle door according to FIGS. 1 and 2;

FIG. 4 shows a detail of a further schematic plan view of the vehicle door according to FIG. 3;

FIG. 5 shows a detail of a schematic perspective view of the motor vehicle having a second embodiment of the vehicle door;

FIG. 6 shows a detail of a schematic sectional view of the second embodiment of the vehicle door; and,

FIG. 7 shows a detail of a schematic sectional view of a third embodiment of the vehicle door.

In the figures, identical or functionally identical elements are provided with the same reference signs.

### DETAILED DESCRIPTION OF THE DRAWINGS

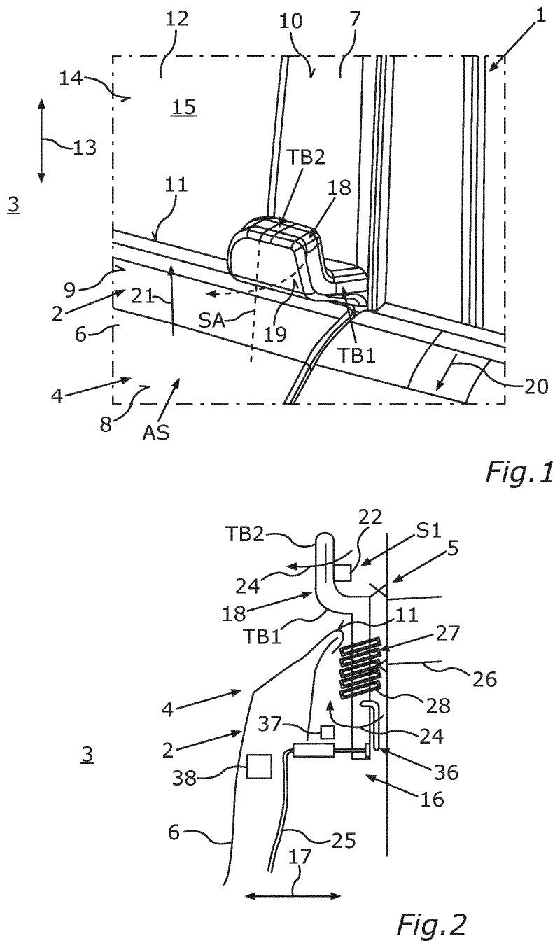

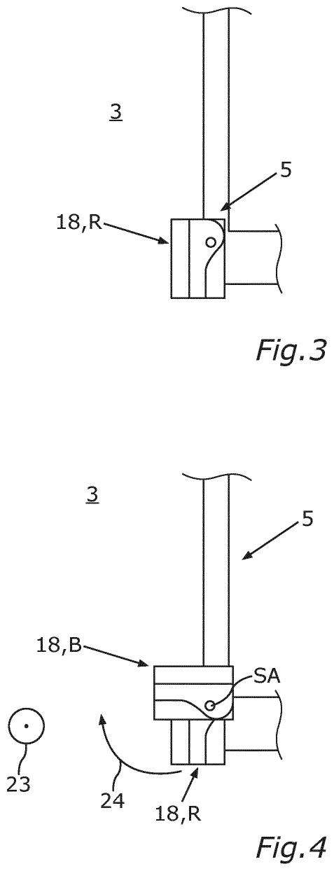

FIG. 1 shows a detail, in a schematic perspective view, of a motor vehicle 1, which is in the form of a passenger car in the present case and is also referred to as a vehicle, the interior of which, which is also referred to as the passenger cabin or passenger compartment, is formed by a structure, in particular in the form of a self-supporting body, of the motor vehicle 1. The motor vehicle 1 has at least one vehicle door 2, which is also referred to simply as a door. The vehicle door 2 is a leaf element, which is in the form of the vehicle door 2 in the present case. The vehicle door 2 is also referred to simply as a door and is a side door in the present case. The vehicle door 2 is assigned a structure opening of the structure, wherein the structure opening, in the exemplary embodiment shown in FIG. 1, is in the form of a side door opening in the structure. The vehicle door 2 is held, and thus arranged, on the structure so as to be movable, in particular pivotable, between a closed position and at least one open position relative to the structure. In the closed position, at least a subregion of the structure opening is closed by the vehicle door 2. In the open position, the vehicle door 2 opens up at least the subregion of the structure opening, such that, for example, a person located in the surroundings 3 of the motor vehicle 1 and thus of the vehicle door 2 can get into the interior via the opened-up subregion of the structure opening. Furthermore, it is possible, for example, for the person initially in the interior can get out of the interior via the opened-up subregion of the structure opening and thus pass into the surroundings 3. The vehicle door 2 has a base body 4, also referred to as basic body or door body, which has a shell 5, which is also referred to as a door shell and a detail of which can be seen in FIG. 2. In this case, FIGS. 1 to 4 show a first embodiment of the vehicle door 2. Via the shell 5, the vehicle door 2 is held on the structure of the motor vehicle 1 so as to be movable, in particular pivotable. The base body 4 has at least one outer paneling element 6, also referred to simply as a paneling element, which is formed separately from the shell 5 and is connected, in particular directly, to the shell 5. The outer paneling element 6 is also referred to as a door panel or door outer panel. At least a first region of the shell 5 is covered and thus clad by the outer paneling element 6 toward the surroundings 3, and thus toward the outside, i.e. in a direction away from the interior, in particular with regard to the closed position of the vehicle door 2. It is apparent from FIG. 1 that the vehicle door 2 has a panel element 7 which is formed, for example, separately from the outer paneling element 6. For example, the panel element 7 is held at least indirectly, in particular directly, on the shell 5. In particular, it is conceivable for at least a second region of the shell 5 to be overlapped and thus covered, i.e. clad, by the panel element 7 toward the surroundings 3, and thus toward the outside, at least with regard to the closed position of the vehicle door 2. The vehicle door 2 has an outer skin, also referred to as overall outer skin 8, which, in the closed position, shown in FIG. 1, of the vehicle door 2, is visually and haptically perceivable by a person located in the surroundings 3. A first part of the overall outer skin 8 is formed by an outer skin, also referred to as a paneling outer skin 9, of the outer paneling element 6. A second part of the overall outer skin 8 is formed by an outer skin, also referred to as a panel element outer skin 10, of the panel element 7. For example, the panel element 7 is formed from a plastic. For example, the panel element 7 is in the form of a trim, or the panel element 7 is also referred to as trim. In particular, provision may be made for a vehicle pillar, in particular in the form of a B-pillar, of the structure to be at least partially overlapped and thus clad toward the outside, and thus toward the surroundings 3, in the vehicle transverse direction of the motor vehicle 1 by way of the panel element 7 in the closed position of the vehicle door 2, and so the panel element 7 is also referred to, for example, as a B-pillar trim.

It is particularly readily apparent from FIG. 1 that the vehicle door 2 has a door shoulder 11, also referred to as a shoulder or window shoulder, which is also referred to as a beltline or forms a beltline of the motor vehicle 1. Furthermore, the vehicle door 2 comprises a side window 12, also referred to simply as a window, which is displaceable in the vehicle vertical direction of the motor vehicle 1 relative to the shell 5 and relative to the outer paneling element 6, at least with respect to the closed position of the vehicle door 2. In particular, the base body 4 comprises, for example, the shell 5, the outer paneling element 6 and the panel element 7. Furthermore, the base body 4 may comprise, for example, the side window 12. It is conceivable for, for example, a third part of the overall outer skin 8 to be formed by an outer skin of the side window 12, also referred to as the window outer skin 14. The vehicle vertical direction is illustrated by a double arrow 13. In particular, the side window 12 can be moved, i.e. displaced, in particular in translation, in the vehicle vertical direction of the motor vehicle 1 between a closed position (shown in FIG. 1) and an open position (not shown) relative to the shell 5 and relative to the outer paneling element 6 and also relative to the panel element 7, at least with regard to the closed position of the vehicle door 2. The open position is also referred to as the window open position, and the closed position is also referred to as the window closed position. In this case, a window region 15 is at least partially delimited by the door shoulder 11, in particular in the installed position of the vehicle door 2 and downwardly in the vehicle vertical direction of the motor vehicle 1. In this case, the installed position of the vehicle door 2 is shown in FIG. 1, wherein the vehicle door 2 takes up its installed position in the completed state of the motor vehicle 1 having the vehicle door 2. In the exemplary embodiment shown in FIG. 1, the window region 15 is a window opening which may be delimited, for example, by a window frame of the vehicle door 2, wherein the window frame may comprise, for example, the door shoulder 11. In particular, by way of example, the window frame is a constituent part of the base body 4. In the closed position, the side window 12 is arranged at least partially in the window region 15, in particular such that the window opening is closed at least partially, in particular at least mostly and thus at least by more than half or entirely, by the side window 12. In particular provision is made for the door shoulder 11, in the closed position (window closed position) of the side window 12, to adjoin the side window 12 downwardly in the vehicle vertical direction in the installed position of the vehicle door 2, in particular with regard to the closed position of the vehicle door 2.

It is apparent from FIG. 2 that the vehicle door 2 has a shaft 16, also referred to as a window shaft, which, in the installed position of the vehicle door 2 and in the closed position of the vehicle door 2, is formed, in particular directly, by the shell 5 and/or the outer paneling element 6 toward the outside and thus toward the surroundings 3 in the vehicle transverse direction. In particular, the shaft 16, in the installed position of the vehicle door 2 and in the closed position of the vehicle door 2, is overlapped by the outer paneling element 6 and/or the shell 5 toward the outside and thus toward the surroundings 3 in the vehicle transverse direction of the motor vehicle 1. The vehicle transverse direction is illustrated by a double arrow 17 in FIG. 2, wherein the closed position and the installed position of the vehicle door 2 are also shown in FIG. 2. In the window open position of the side window 12, a subregion, also referred to as a window subregion, of the side window 12 is thus arranged in the shaft 16 and thus in particular outside the window region 15, in particular such that the window subregion is arranged, in the open position, beneath the door shoulder 11 and also beneath the window region 15 in the vehicle vertical direction of the motor vehicle 1, in particular with regard to the installed position of the vehicle door 2 and with regard to the closed position of the vehicle door 2. In the closed position (window closed position) of the side window 12, the window subregion is arranged outside the shaft 16 and in the window region 15, in particular such that the window subregion is arranged above the door shoulder 11 in the vehicle vertical direction, in particular at least with regard to the installed position and to the closed position of the vehicle door 2. In other words, in the window closed position, the door shoulder 11 adjoins the window subregion downwardly in the vehicle vertical direction. For example, in the closed position (window closed position) of the side window 12, the window region 15 or the window opening is closed at least partially, in particular at least mostly and thus by more than half or entirely, by the window subregion.

The vehicle door 2 furthermore has a handle element 18 on the outside of the door, also referred to as an outer handle or door outer handle. In the installed position of the vehicle door 2 and with regard to the closed position of the vehicle door 2, the handle element 18 is arranged, in particular at least partially and highly preferably at least mostly or entirely, above the door shoulder 11 in the vehicle vertical direction of the motor vehicle 1. The feature whereby the handle element 18 is arranged on the outside of the door or externally, and is thus an external handle element or a handle element on the outside of the door, should be understood as meaning that the handle element 18 is arranged on an outer side AS of the vehicle door 2, the outer side AS of which, in the installed position of the vehicle door 2 and at least in the closed position of the vehicle door 2, faces away from the interior and faces the surroundings 3. The person located in the surroundings 3 can, for example, take hold of the handle element 18 with their hand and in the process, for example, at least partially grasp it, and subsequently exert a force, in particular a pulling force, on the handle element 18 in order, as a result, for example, to open the initially closed vehicle door 2, and thus to move it from the closed position into the open position relative to the structure.

The handle element 18 has an outer skin, also referred to as a handle element outer skin 19, which is visually and haptically perceivable by a person located in the surroundings 3 of the vehicle door 2, in particular of the motor vehicle 1 as a whole, and which forms, for example, a fourth prat of the overall outer skin 8, and thus which is, in particular, a fourth part of the overall outer skin 8.

In order for it to be possible to operate, in particular to actuate, the vehicle door particularly easy, in particular ergonomically and comfortably, the handle element 18 has a first subregion TB1, also referred to as first body region or first body part, having a first extension direction, which is also referred to as a first direction and is illustrated in FIG. 1 by an arrow 20. The first subregion TB1 extends along the first direction. In the exemplary embodiment shown in FIG. 1, provision is made for the first subregion TB1 to protrude from the base body 4, in particular from the panel element 7, in the first direction (arrow 20). In particular, the first direction extends in the vehicle transverse direction, in particular outwardly, in the installed position of the vehicle door 2 and with regard to the closed position of the vehicle door 2. The handle element 18 also has a second subregion TB2, which is also referred to as second body region or second body part. The second subregion TB2 protrudes from the first subregion TB1 in a second extension direction which is illustrated in FIG. 1 by an arrow 21 and which is also referred to as a second direction. In this case, the second subregion TB2 extends along the second extension direction. It is apparent from the arrows 20 and 21 that the first direction and the second direction extend perpendicularly or obliquely with respect to one another, wherein, in the present case, the second direction is directed upwardly in the vehicle vertical direction, in particular in the installed position of the vehicle door 2 and with regard to the closed position of the vehicle door 2. In particular, the second subregion TB2 adjoins an end of the subregion TB1 that faces away from the base body 4, in particular along the first direction, such that, or with the result that, in the first embodiment, the handle element 18, in particular considered overall, is L-shaped and thus, in particular considered overall, has an L-shape. In this case, the L-shape is formed by the subregions TB1 and TB2. Thus, the handle element 18 is L-shaped in the first embodiment. In this case, the subregions TB1 and TB2 are respective legs of the L-shape, wherein the handle element 18 is attached to the base body 4, in particular to the shell 5, via the subregion TB1. The subregion TB2 adjoins the subregion TB1, in particular in the present case such that the subregion TB2 adjoins an end of the first subregion TB1 that faces away from the base body 4 in particular along the first direction.

In order for it to be possible to realize particularly advantageous operation, an operating element 22, which is illustrated particularly schematically in FIG. 2, is integrated into the handle element 18, in particular into the second subregion TB2, the operating element being arranged in particular on an inner side S1, facing the base body 4, in particular facing the panel element 7, of the handle element 18, in particular of the second subregion TB2. It is particularly readily apparent from FIG. 2 that the subregions TB1 and TB2 are arranged above the door shoulder 11 in the vehicle vertical direction of the motor vehicle 1 in the installed position of the vehicle door 2 and with regard to the closed position of the vehicle door 2. The operating element 22 is arranged above the door shoulder 11 in the vehicle vertical direction of the motor vehicle 1 in the installed position of the vehicle door 2 and with regard to the closed position of the vehicle door 2. By way of the operating element 22, a lock, in the form of a door lock in the present case, can be unlocked electrically by operating, in particular actuating, the operating element 22. The lock is, for example, a constituent part of the vehicle door 2 and thus movable, in particular pivotable, conjointly with the vehicle door 2 relative to the structure of the motor vehicle 1 between the open position and the closed position of the vehicle door 2. By way of the lock, the vehicle door 2 can be held in the closed position and thus secured in the closed position relative to the structure, such that the vehicle door 2 can be secured by way of the lock against moving, relative to the structure, from the closed position into the open position. To this end, the lock is locked in the closed position of the vehicle door 2, i.e. is adjusted into a locked state of the lock. As a result of the operating element 22 being operated, the lock can be unlocked electrically, i.e. passed, i.e. transferred, electrically from the locked state into an unlocked state of the lock. As a result of the lock being transferred from the locked state into the unlocked state of the lock, the lock allows the vehicle door 2, initially located in the closed position, to move relative to the structure of the motor vehicle 1 from the closed position into the open position.

In order now for it to be possible to realize particularly advantageous, in particular particularly reliable, operation of the vehicle door 2, provision is also made for the handle element 18 to be held on the base body 4, in particular on the shell 5, so as to be movable relative to the base body 4 and thus relative to the shell 5, relative to the outer paneling element 6, relative to the panel element 7 and also relative to the side window 12 from a rest position, shown in FIGS. 1, 2 and 3 and designated R, into an actuating position B shown in FIG. 4, in particular between the rest position R and the actuating position B. As a result of the handle element 18 being moved from the rest position R into the actuating position B, the lock can be unlocked mechanically, in particular purely mechanically, and thus can be transferred, in particular purely mechanically, from the locked state into the unlocked state.

In the first embodiment shown in FIGS. 1 to 4, the handle element 18 is pivotable relative to the base body 4 about a pivot axis SA between the rest position R and the actuating position B. In the first embodiment, the pivot axis SA extends, in the closed position of the vehicle door 2 and with regard to the installed position of the vehicle door 2, at least substantially in the vehicle vertical direction, which is illustrated for example in FIG. 4 by a double arrow 23 and extends perpendicularly to the drawing plane of FIG. 4. In the first embodiment, the handle element 18 is pivotable, with regard to the closed position and with regard to the installed position of the vehicle door 2, forwardly in the vehicle longitudinal direction from the rest position R into the actuating position B, this being illustrated by respective arrows 24 in FIGS. 2 and 4. In the first embodiment, the mechanical, in particular purely mechanical, unlocking of the lock takes place for example in the following way: Also provided is a pulling element 25, also referred to as cable element, which is in the form, for example, of a wire or of a wire cable. In particular, the pulling element 25 is in the form, for example, of a Bowden cable. The pulling element 25 is coupled, in particular mechanically, on one side, in particular at one end, to the handle element 18. On the other side, in particular at the other end, the pulling element 25 is coupled, in particular mechanically, for example to the lock. If the handle element 18 is moved manually, for example by the person located in the surroundings 3, from the rest position R into the actuating position B relative to the base body 4, a force, in the form of a pulling force, acts as a result on the pulling element 25 in particular by way of the handle element 18, the force being transmitted to the lock via the pulling element 25 and subsequently unlocking the lock, and thus transferring the lock from the locked state into the unlocked state. Subsequently, the vehicle door 2 can be opened, and thus be moved from the closed position into the open position relative to the structure. Put simply, as a result of the handle element 18 being moved from the rest position R into the actuating position B, the pulling element 25 is pulled, with the result that the lock is unlocked mechanically, in particular purely mechanically, i.e. without any use of electrical or other energy.

It is apparent from FIG. 2 that, for example, a holder 26, also referred to as a holding element, is provided. The holder 26 is formed, for example, separately from the shell 5 and fastened to the shell 5, in particular by at least one or more screws. In other words, the holder 26 is screwed to the shell 5, for example. The handle element 18 is held on the shell 5 and thus on the base body 4 so as to be movable, by way of the holder 26, between the rest position R and the actuating position B relative to the shell 5, in particular such that the handle element 18 is held on the holder 26 so as to be movable relative to the holder 26 between the rest position R and the actuating position B.

The vehicle door 2 is configured such that, when the operating element 22 is operated and the lock is unlocked electrically as a result, there is no movement of the handle position 18 from the rest position R into the actuating position B, i.e. the handle element 18 remains in its rest position R, in particular such that there are no relative movements between the handle element 18 and the base body 4. For this purpose, a retention device 27 is provided, which is also referred to as a force coupling or may be in the form of a force coupling. The retention device 27 secures the handle element 18 relative to the base body 4 in the rest position R up to a limit force and passively, in particular purely passively, allows the movement, relative to the base body 4, of the handle element 18 from the rest position R into the actuating position B, in particular and very particularly only when an actuating force acting on the handle element 18 and provided to move the handle element 18 from the rest position R into the actuating position B exceeds the limit force. Preferably, the limit force is greater than 90 newtons. For this purpose, the retention device 27, for example, comprises at least one spring element 28, which is in the form, for example, of a torsion spring, and is a mechanical spring in the present case. Via the spring element 28, the handle element 18, for example, is supported or able to be supported at least indirectly on the base body 4, in particular on the shell 5, in particular such that the spring element 28 is supported or able to be supported for example on one side at least indirectly, in particular directly, on the handle element 18 and on the other side at least indirectly, in particular directly, on the base body 4, in particular on the shell 5. The spring element 28 provides a spring force which secures the handle element 18 in the rest position R and passively, in particular purely passively, allows the movement, relative to the base body 4, of the handle element 18 from the rest position R into the actuating position B when, and preferably only when, an actuating force acting on the handle element 18 exceeds the limit force. In other words, the handle element 18 can be moved only counter to the spring force from the rest position R into the actuating position B and in particular from the rest position R into the actuating position B relative to the base body 4 only when the actuating force exceeds the limit force.

Preferably, the rest position R is a stable position in which there are no relative movements between the handle element 18 and the base body 4. In particular, for example, the handle element 18 is held in the rest position R relative to the base body 4 by way of the retention device 27, in particular such that there are no relative movements between the handle element 18 and the base body 4. Highly preferably, the actuating position B is an in particular further stable position of the handle element 18, wherein, preferably, the handle element 18 is movable into the actuating position B and is able to be fixed in the actuating position B relative to the base body 4, in particular such that, in the actuating position B, there are no relative movements between the handle element 18 and the base body 4. For this purpose, provision is made, for example, of a fixing device, by way of which the handle element 18, once it has been moved from the rest position R into the actuating position B, is or can be held in the actuating position B relative to the base body 4.

It is apparent that the limit force is a force threshold that has to be overcome in order for it to be possible to move the handle element 18 relative to the base body 4, in particular into the actuating position B or in the direction of the actuating position B. Alternatively or additionally, for this purpose, it is possible, for example for the retention device 27 to have two retention elements, for example in the form of disks, namely a first retention element fastened for example at least indirectly, in particular directly, to the shell 5 and a second retention element that is provided for example at least indirectly on the handle element 18 and is movable conjointly with the handle element 18. One of the retention elements has, for example, at least one or more protrusions, in particular studs. The other retention element has, for example, at least one or more indentations that correspond to the protrusions, wherein, for example, the respective protrusion engages, in the rest position R, in the respective, corresponding indentation. In order for it to be possible to move the handle element 18 relative to the base body 4, in particular to be able to move it from the rest position R in to the actuating position B, the respective protrusion has to be moved, in particular pivoted, out of the respective, corresponding indentation. For this purpose, the limit force (force threshold) has to be overcome. Alternatively or additionally, it is conceivable for the handle element 18, by way of the retention device 27, to be held in a positive locking manner in the rest position R, in particular to be latched in the rest position R. In order for it to be possible to move the handle element 18 relative to the base body 4, in particular from the rest position R into the actuating position B, the positively locking securing has to be undone, and thus the handle element 18 has to be unlatched. Only then can the handle element 18 be moved from the rest position R into the actuating position B. As a result, advantageous and clear operation or actuation of the vehicle door 2 can be ensured. In particular, it is possible, for example, for the person located in the surroundings 3 to exert an operating force on the operating element 22 in order, as a result, to effect the electric unlocking of the lock. To this end, the operating force exerted by the person acts, for example, on the operating element 22 in an operating direction. If the operating force is lower than the limit force or if the operating force corresponds to the limit force, the handle element 18 remains in the rest position R. However, if the operating force exceeds the limit force, the handle element 18 is moved from the rest position R into the actuating position B relative to the base body 4. Thus, the lock can be unlocked mechanically as it were in continuation of the operation of the operating element 22 via the handle element 18, since the person can exert the operating force in the same direction on the operating element 22 and, via the latter, on the handle element 18 in order to effect the electric unlocking and the mechanical unlocking of the lock. To mechanically unlock the lock, the operating force has to exceed the limit force, however.

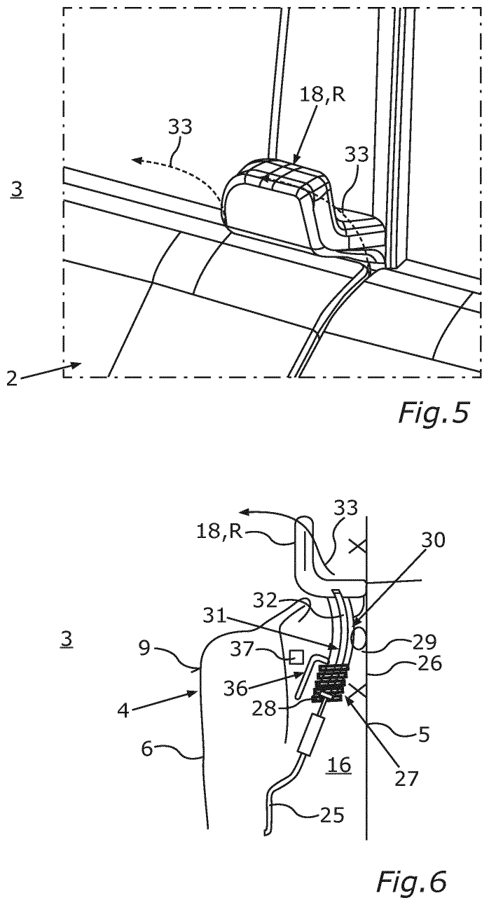

FIGS. 5 and 6 show a second embodiment of the vehicle door 2. In FIGS. 5 and 6, the movement or movability of the handle element 18 from the rest position R into the actuating position B is illustrated by arrows 33. In the second embodiment, the vehicle door 2 has a first guide device 29 provided on the base body 4, in particular on the shell 5. The first guide device 29 is secured for example at least indirectly, in particular directly, to the shell 5 and is thus, for example, immovable relative to the shell 5. The first guide device 29 has a guide slot 30. Provided on the handle element 18 is a second guide device 31 which is movable conjointly with the handle element 18 relative to the base body 4 from the rest position R into the actuating position B, in particular between the rest position R and the actuating position B. The second guide device 31 comprises at least one guide element 32 which engages in the guide slot 30. As a result, the guide devices 29 and 31 cooperate in a positive locking manner. As a result, the guide devices 29 and 31 define or form a movement path, which is illustrated in particular by the arrow 33 shown in FIG. 6 and along which the handle element 18 is movable in a guided manner relative to the base body 4 from the rest position R into the actuating position B, in particular between the rest position R and the actuating position B.

By way of example, the guide device 29 is held at least indirectly on the shell 5, for example via the holder 26. Furthermore, it is conceivable for the guide device 29 to be held directly on the shell 5. Furthermore, it is conceivable for the guide device 29 to be fastened, in particular secured, directly to the holder 26 and, via the holder 26, to the shell 5. It is particularly readily apparent from FIG. 6 that, in the second embodiment, the movement path extends in an arcuate manner, in the present case such that, in the installed position of the vehicle door 2 and with regard to the closed position of the vehicle door 2, the arcuate movement path is curved toward the interior of the motor vehicle 1 and is thus curved away from the surroundings 3. Thus, the handle element 18 moves, on its path from the rest position R into the actuating position B, upwardly in the vehicle vertical direction and outwardly in the vehicle transverse direction, and thus away from the interior, in particular with regard to the installed position of the vehicle door 2 and with regard to the closed position of the vehicle door 2. Again, put another way, the handle element 18 is further up in the vehicle vertical direction and further out in the vehicle transverse direction in the actuating position B compared with rest position R, and thus arranged farther away from the interior, in particular with regard to the closed position and the installed position of the vehicle door 2. This is realized in the present case such that the guide slot 30 is curved toward the interior in the installed position and in the closed position of the vehicle door 2.

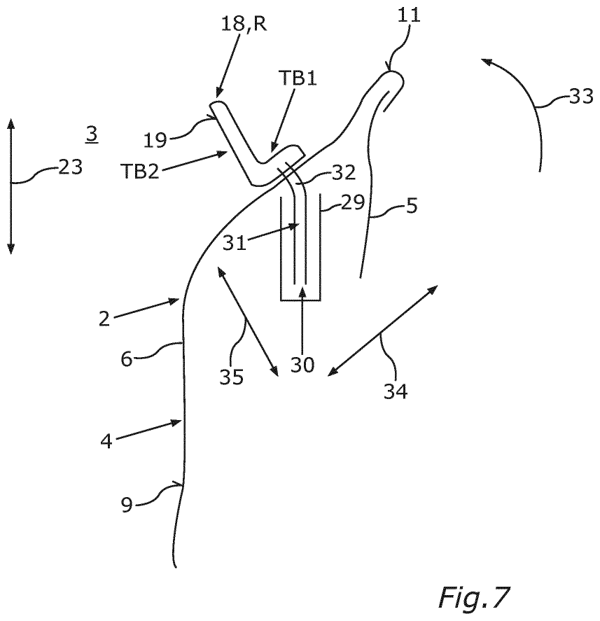

Finally, FIG. 7 shows a detail, in a schematic sectional view, of a third embodiment of the vehicle door 2. The third embodiment differs from the second embodiment in particular in that, in the third embodiment, the handle element 18, and thus the subregions TB1 and TB2, are arranged entirely beneath the door shoulder 11 in the vehicle vertical direction (double arrow 23) in the installed position of the vehicle door 2 and in the closed position of the vehicle door 2.

In the third embodiment, too, the handle element 18 has the handle element outer skin 19, wherein the subregion TB1 forms or has a first part and the subregion TB2 forms or has a second part of the handle element outer skin 19. The subregion TB1 has the first extension direction, which is illustrated by a double arrow 34 in FIG. 7 and along which the first subregion TB1 extends. The second subregion TB2 has the second extension direction, which is illustrated by a double arrow 35 in FIG. 7 and along which the second subregion TB2 extends. It is apparent that the extension directions extend obliquely or, in the present case, perpendicularly to one another. In the third embodiment, too, the subregions TB1 and TB2 form an L-shape of the handle element 18, which is thus formed overall with an L-shape in the third embodiment, too. In this case, the subregions TB1 and TB2 are legs of the L-shape. In the rest position R shown in FIG. 7, the first extension direction extends parallel to a plane in which an outer skin part of the paneling outer skin 9 of the outer paneling element 6 extends. In this case, it is conceivable for the subregion TB1 to bear, in the rest position R, in particular directly, on the outer skin part of the paneling outer skin 9. Thus, for example, in the third embodiment, the subregion TB2 protrudes from the subregion TB1 and from the paneling outer skin 9 along or in the second extension direction. The previous and following statements about the first embodiment and about the second embodiment can also be transferred to the third embodiment and vice versa. Since, in the third embodiment, too, the handle element 18 is at least substantially L-shaped, in the third embodiment, too, ergonomic and comfortable operation, in particular actuation, of the handle element 18 and thus of the vehicle door 2 as a whole can be provided. It is apparent, in particular, from FIG. 7 that the second subregion TB2 protrudes from the subregion TB1 along or in the second extension direction, in particular from the end thereof, which is adjoined by the subregion TB2, in particular only in the second extension direction. Very particularly, provision is made for the handle element 18 as a whole, i.e. considered as a whole, to have the L-shape, i.e. to be L-shaped.

In the first embodiment, the second embodiment and the third embodiment, since the second subregion TB2 protrudes from the first subregion TB1 in the second extension direction (arrow 21 and double arrow 35), the handle element 18 as a whole, i.e. considered overall, is L-shaped or V-shaped and thus has an L-shape or a V-shape overall, wherein the subregion TB1 and TB2 form or are legs of the respective L-shape or V-shape.

Furthermore, it is apparent from the example of the first embodiment and of the second embodiment, and in particular from FIGS. 2 and 6, that the vehicle door 2 has an actuating device 36 by way of which the handle element 18 is movable, in particular along the movement path, relative to the base body 4 from the rest position R into an intermediate position located between the rest position R and the actuating position B, and can be held, i.e. fixed, in the intermediate position relative to the base body 4. This means that the handle element 18 is fixed, i.e. held, in the intermediate position relative to the base body 4 by way of the actuating device 36, such that, while the handle element 18 is in the intermediate position, there are no relative movements between the handle element 18 and the base body 4. During or as a result of the movement of the handle element 18 from the rest position R into the actuating position B, the lock is not unlocked mechanically. In order to unlock the lock mechanically, the handle element 18 is movable or moved from the intermediate position into the actuating position B relative to the base body 4.

The actuating device 36 comprises, for example, an actuator 37, which is also referred to as actuating actuator or first actuator. For example, the actuator 37 is electrically operable, and is thus an electrically operable actuator. This means that the actuator 37 is able to be energized, and thus able to be supplied with electrical energy or electric current. In an energized state of the actuator 37, the actuator 37 is supplied with electrical energy. In a deenergized state of the actuator 37, the actuator 37 is not supplied with electrical energy.

In a first variant, it is possible for the actuating device 36 to have a spring element, in particular a mechanical spring element, which is also referred to as an actuating spring element or actuating spring and is tensioned, for example, at least in the rest position R or provides, at least in the rest position R, a spring force also referred to as an actuating force. In the energized state of the actuator 37, the actuator 37 keeps, for example, the actuating spring at least indirectly, in particular directly, tensioned, in particular actively, such that there is no movement, effected by the actuating force, of the handle element 18 from the rest position R into the intermediate position. In this case, it is conceivable for the actuator 37, in its energized state, to cooperate directly with the actuating spring and thus to directly keep the actuating spring tensioned, or a further retention element is provided, which is in the form, for example, of a hook and is provided in particular in addition to the actuator 37 and in addition to the actuating spring, wherein, for example, the actuator, in its energized state, tensions the actuating spring, i.e. keeps it in its tensioned state, via the further retention element, such that there is no movement, effected by the actuating force, of the handle element 18 from the rest position R into the intermediate position. The actuator 37 is transferable from its energized state into its deenergized state, in particular as a result of a power supply of the actuator 37 failing, and thus being interrupted, for example as a result of an accident or for some other reason. As a result of the actuator 37 being transferred from its energized state into its deenergized state, the actuator 37 releases the actuating spring for at least partial relaxation of the actuating spring, such that, subsequently, the actuating spring moves the handle element 18 from the rest position R into the intermediate position, and thus the handle element 18 is moved by way of the actuating force from the rest position R into the intermediate position. For example, as a result of the actuator 37 being transferred from its energized state into its deenergized state, the actuator 37 releases the further retention element for a movement in translation and/or rotation, effected or able to be effected in particular by the spring force (actuating force), in particular relative to a basic element, such that the further retention element releases the actuating spring for at least partial relaxation of the actuating spring and subsequently the actuating spring moves the handle element 18 from the rest position R into the intermediate position relative to the base body 4.

In a second variant, it is conceivable for the actuator 37 to be in the form of, to be operable as or to act as a drive or motor. In this case, for example, the actuator 37 is an electrically operable actuator, wherein the actuating device 36 has, for example, an electrical energy store 38 in which electrical energy is stored. The energy store 38 is in this case assigned specifically to the actuator 37 such that the actuator 37 is able to be supplied with the electrical energy stored in the energy store 38 independently of the rest of the motor vehicle 1. As a result of the actuator 37 being supplied with the electrical energy stored in the energy store 38, the actuator 37 is operable or operated electrically. As a result of the actuator 37 being operated electrically, the actuator 37 drives the handle element 18 at least indirectly, such that the handle element 18 is moved from the rest position R in the intermediate position by way of the actuator 37 and thus actively. The actuator 37 is not supplied with electrical energy via an energy store provided in addition to the energy store 38 in this case. As a result, if, for example, the power supply fails and if the motor vehicle 1 is involved in an accident, it is possible for a movement of the handle element 18 from the rest position R into the intermediate position to be ensured, such that, as it were, the person located in the surroundings is presented with the handle element 18 in the intermediate position. As a result, the person is made visually aware that they can move the handle element 18, in particular from the intermediate position into the actuating position B, with the result that the lock is unlocked mechanically. Subsequently, the vehicle door 2 can be opened.

### List of Reference Signs

1 Motor vehicle
2 Vehicle door
3 Surroundings
4 Base body
5 Shell
6 Outer paneling element
7 Panel element
8 Overall outer skin
9 Paneling outer skin
10 Panel element outer skin
11 Door shoulder
12 Side window
13 Double arrow
14 Window outer skin
15 Window region
16 Shaft
17 Double arrow
18 Handle element
19 Handle element outer skin
20 Arrow
21 Arrow
22 Operating element
23 Double arrow
24 Arrow
25 Pulling element
26 Holder
27 Retention device
28 Spring element
29 First guide device
30 Guide slot
31 Second guide device
32 Guide element
33 Arrow
34 Double arrow
35 Double arrow
36 Actuating device
37 Actuator
38 Energy store
AS Outer side
B Actuating position
R Rest position
S1 Inner side
SA Pivot axis
TB1 Subregion
TB2 Subregion

1.-10. (canceled)

11. A vehicle door for a motor vehicle, having a handle element arranged on the outside of the door, above a door shoulder of the vehicle door, wherein:
an operating element is integrated into the handle element, by way of which operating element a lock, by way of which the vehicle door, which is able to be arranged on a structure of the motor vehicle so as to be movable between a closed position and at least one open position, is able to be secured in the closed position, is unlockable electrically;
the handle element is held on a base body of the vehicle door so as to be movable relative to the base body from a rest position (R) into at least one actuating position (B), wherein, as a result of the handle element being moved from the rest position (R) into the actuating position (B), the lock is unlockable mechanically; and
an actuating device is provided, by way of which the handle element is movable relative to the base body from the rest position (R) into an intermediate position located between the rest position (R) and the actuating position (B) and can be held in the intermediate position relative to the base body.

12. The vehicle door according to claim 11, wherein the handle element has:
an outer skin that is visually and haptically perceivable by a person located in the surroundings of the vehicle door;
a first subregion (TB1), forming a first part of the outer skin of the handle element, with a first extension direction; and
a second subregion (TB2), forming a second part of the outer skin of the handle element and adjoining the first subregion (TB1), the second subregion protruding from the first subregion (TB1) in at least a second extension direction extending obliquely or perpendicularly to the first extension direction.

13. The vehicle door according to claim 12, wherein the handle element is L-shaped or V-shaped.

14. A vehicle door for a motor vehicle, having a handle element arranged on the outside of the door, beneath a door shoulder of the vehicle door, wherein:
an operating element is integrated into the handle element, by way of which operating element a lock, by way of which the vehicle door, which is able to be arranged on a structure of the motor vehicle so as to be movable between a closed position and at least one open position, is able to be secured in the closed position, is unlockable electrically;
the handle element is held on a base body of the vehicle door so as to be movable relative to the base body from a rest position (R) into at least one actuating position (B), wherein, as a result of the handle element being moved from the rest position (R) into the actuating position (B), the lock is unlockable mechanically;
an actuating device is provided, by way of which the handle element is movable relative to the base body from the rest position (R) into an intermediate position located between the rest position (R) and the actuating position (B) and can be held in the intermediate position relative to the base body; and
the handle element has:
an outer skin that is visually and haptically perceivable by a person located in the surroundings of the vehicle door;
a first subregion (TB1), forming a first part of the outer skin of the handle element, with a first extension direction; and
a second subregion (TB2), forming a second part of the outer skin of the handle element and adjoining the first subregion (TB1), the second subregion protruding from the first subregion (TB1) in at least a second extension direction extending obliquely or perpendicularly to the first extension direction, with the result that the handle element is L-shaped or V-shaped.

15. The vehicle door according to claim 14, wherein:
the actuating device has an actuator and an energy store which is assigned specifically to the actuator and in which energy is stored, with which the actuator is able to be supplied independently of the rest of the motor vehicle, with the result that the actuator is operable, and as a result of the actuator being operated, the handle element is movable from the rest position (R) into the intermediate position.

16. The vehicle door according to claim 15, wherein:
the energy store stores electrical energy with which the electrically operable actuator is able to be supplied and as a result to be operated.

17. The vehicle door according to claim 14, wherein:
the actuating device has at least one spring element which is tensioned at least in the rest position (R) and as a result provides a spring force by way of which the handle element is movable from the actuating position (B) into the intermediate position.

18. The vehicle door according to claim 14, wherein:
the actuating device is designed to move the handle element from the rest position (R) into the intermediate position if the motor vehicle is involved in an accident.

19. The vehicle door according to claim 14, wherein:
the actuating device is designed to move the handle element automatically from the rest position (R) into the intermediate position in the event of an interruption to a power supply of the operating element and/or of the actuating device and/or of at least one other, further component of the motor vehicle.

20. A motor vehicle having at least one vehicle door according claim 14.
